(19) United States
(12) Patent Application Publication
(10) Pub. No.: US 2024/0183363 A1
(43) Pub. Date: Jun. 6, 2024

(54) ON-VEHICLE AXIAL FLOW BLOWER

(71) Applicant: Greenworks (Jiangsu) Co., Ltd., Changzhou (CN)

(72) Inventor: Yunjie SHANGGUAN, Changzhou (CN)

(73) Assignee: Greenworks (Jiangsu) Co., Ltd., Changzhou (CN)

(21) Appl. No.: 18/523,836

(22) Filed: Nov. 29, 2023

(30) Foreign Application Priority Data
Dec. 1, 2022 (CN) 202211527028.1
Dec. 1, 2022 (CN) 202223203956.0

(51) Int. Cl. F04D 29/64; F04D 19/00; F04D 25/06

(52) U.S. Cl. CPC F04D 29/646; F04D 19/002; F04D 25/06

(57) ABSTRACT

An on-vehicle axial flow blower includes a housing assembly, a blowing assembly and a rotating assembly. The blowing assembly includes an air inlet assembly, an air outlet assembly, and duct assembly; the duct assembly include a motor, a guiding cone mounted at one end of the motor, and an axial fan mounted at the other end of the motor; and the motor is a brushless motor. The rotating assembly includes a control handle, a first turntable, a fastening assembly penetrating through the first turntable, a control cable connecting the control handle with the fastening assembly, and a second turntable below the first turntable. The control handle is configured as follows: When the control handle is pressable to control the control cable to drive the fastening assembly to detach from or reinsert into the fastening hole.

### CROSS REFERENCE TO RELATED APPLICATION

The present application claims the priority of the following Chinese patent applications: serial No. 202211527028.1, filed Dec. 01, 2022 and serial No. 202223203956.0, filed Dec. 01, 2022; the disclosures of which are hereby incorporated by reference herein in their entireties for all purposes.

### TECHNICAL FIELD

The present disclosure relates to an on-vehicle axial flow blower, and belongs to the field of blower technologies.

### BACKGROUND

A centrifugal fan is usually used for a conventional on-vehicle blower because the centrifugal fan has advantages of a large size and a high airflow. However, the centrifugal fan has a low air flow rate when rotating. In order to improve the air flow rate, a manner of increasing a power is usually used, leading to high power consumption and low blowing efficiency.

In addition, it is not easy to fix an angle when the typical on-vehicle blower moves for blowing, which makes it difficult to rotate the blower.

In view of this, it is necessary to improve an existing on-vehicle blower to resolve the foregoing problems.

### SUMMARY

An objective of some exemplary embodiments of the present disclosure is to provide an on-vehicle axial flow blower, to resolve technical problems of a low air flow rate, high power consumption, and low blowing efficiency when use a centrifugal fan blade, and further to achieve rotational blowing.

To implement the foregoing objective, the present disclosure provides an on-vehicle axial flow blower, including:

a housing assembly;

a blowing assembly, including an air inlet assembly, an air outlet assembly, and a duct assembly connected between the air inlet assembly and the air outlet assembly, where the duct assembly includes a motor, a guiding cone mounted at a first end of the motor, and an axial fan mounted at a second end of the motor; and

a rotating assembly, including a control handle, a first turntable, a fastening assembly penetrating through the first turntable, a control cable connecting the control handle with the fastening assembly, and a second turntable arranged below the first turntable, where a first end of the first turntable is fixedly connected to the housing assembly and the blowing assembly, a second end of the first turntable is rotatably connected the second turntable a plurality of fastening holes is disposed on the second turntable, and the control handle is configured as follows: when the control handle is pressed, the control cable drives the fastening assembly to detach from the fastening hole; and after the control handle is released, the fastening assembly drives the control cable to automatically reset, and then the fastening assembly is reinserted into the fastening hole.

In some exemplary embodiments, the plurality of fastening holes on the second turntable is arranged in an arc shape and are spaced from each other, and there is an equal distance between each fastening hole and a rotation axis of the first turntable.

In some exemplary embodiments, the fastening assembly includes a fastening base fixedly connected to the first turntable, a fastener fixedly connected to the control cable, and a spring sleeved outside the fastener, and the fastener is configured to pass through the fastening base and limit the spring between the fastener and the fastening base.

In some exemplary embodiments, when the control handle is pressed, the control cable pulls the fastener to move upward, the spring is compressed, and the fastener is detached from the fastening hole; and after the control handle is released, the spring pushes the fastener to move downward, so that the fastener is reinserted into the fastening hole.

In some exemplary embodiments, the first turntable is further fastened with a limiting base, and one end that is of the control cable and that is connected to the fastener is accommodated in the limiting base and is capable of moving up and down synchronously with the fastener in the limiting base.

In some exemplary embodiments, the rotating assembly further includes a bearing fastening post fastened on the second turntable, a bearing sleeved on the bearing fastening post, and a bearing sleeve fastened on the first turntable, and the bearing fastening post and the bearing pass through the first turntable and are accommodated in the bearing sleeve, so that the first turntable is capable of rotating relative to the second turntable.

In some exemplary embodiments, the bearing includes a first bearing and a second bearing arranged above the first bearing, the first bearing is sleeved on the bearing fastening post and passes through the first turntable together with the bearing fastening post, to be accommodated at a bottom part of the bearing sleeve, and the second bearing enters from a top part of the bearing sleeve and is sleeved on the bearing fastening post.

In some exemplary embodiments, the rotating assembly further includes a locking member, the locking member enters from the top part of the bearing sleeve to be sleeved on a top part of the bearing fastening post, and the locking member is locked on the bearing fastening post to connect the first turntable with the second turntable.

In some exemplary embodiments, the air inlet assembly includes an air inlet and an air inlet pipe connected to the air inlet, the air inlet pipe is accommodated in the housing assembly and is connected to the motor, and the axial fan is arranged close to the air inlet pipe to drive external air to enter the air inlet pipe from the air inlet.

In some exemplary embodiments, the air inlet assembly further includes an air inlet cover assembled to the housing assembly, and the air inlet is arranged on the air inlet cover.

In some exemplary embodiments, the on-vehicle axial flow blower includes two duct assemblies, the air outlet assembly includes two air outlet pipes connected to the two duct assemblies respectively, and the first turntable is provided with penetrating holes for the two air outlet pipes to pass through.

In some exemplary embodiments, the air outlet pipe is an elbow pipe.

In some exemplary embodiments, the housing assembly includes a first housing and a second housing matched with each other, both the first housing and the second housing are fastened on an upper surface of the first turntable, the duct assembly is accommodated in an accommodating cavity enclosed by the first housing and the second housing, and the duct assembly is arranged perpendicular to the first turntable.

In some exemplary embodiments, the housing assembly further includes a control assembly fastened on an outer side of the first housing and a protective cover covering an outer side of the control assembly, and the protective cover and the first housing are matched with each other, to limit the control assembly between the protective cover and the first housing.

In some exemplary embodiments, the motor is a brushless motor.

A beneficial effect of the present disclosure is as follows: In the on-vehicle axial flow blower provided by embodiments of the present disclosure, after the axial fan is used, there are advantages of a significantly improved air flow rate, a smaller volume of a required space, higher blowing efficiency at a same condition. In addition, a structure of the rotating assembly is adjusted. In this way, quick direction turning can be implemented through rotatable connection between the first turntable and the second turntable, and the fastening assembly and the fastening hole can fit with each other by pressing the control handle. Therefore, the first turntable is fixedly connected with the second turntable, a rotation angle is limited, and rotational blowing is more easily and conveniently operated.

### BRIEF DESCRIPTION OF DRAWINGS

FIG. 1 is a perspective view of an on-vehicle axial flow blower according to the present disclosure;

FIG. 2 is a partially exploded view of the on-vehicle axial flow blower in FIG. 1;

FIG. 3 is an exploded view of the on-vehicle axial flow blower in FIG. 2;

FIG. 4 is an exploded view of a housing assembly in FIG. 2;

FIG. 5 is a perspective view of a blowing assembly in FIG. 2;

FIG. 6 is an exploded view of the blowing assembly in FIG. 5;

FIG. 7 is a cross-sectional view of a rotating assembly in FIG. 2;

FIG. 8 is an exploded view of a rotating assembly in FIG. 2;

FIG. 9 is an exploded view obtained after a control handle and a control cable in FIG. 8 are removed; and

FIG. 10 is a schematic diagram of FIG. 9 from another perspective.

### DESCRIPTION OF EMBODIMENTS

In order to make the objective, technical solutions, and advantages of the present disclosure clearer, the following describes the present disclosure in detail with reference to the accompanying drawings and specific embodiments.

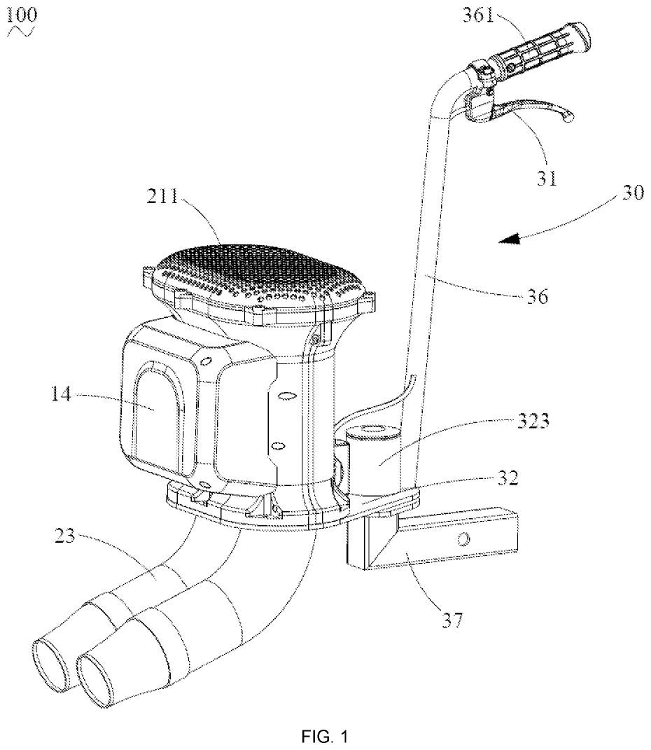

As shown in FIG. 1 to FIG. 3, the present disclosure discloses an on-vehicle axial flow blower 100, including a housing assembly 10, a blowing assembly connected to the housing assembly 10, and a rotating assembly 30, where the blowing assembly includes an air inlet assembly 21, an air outlet assembly 23, and a duct assembly 22 connected between the air inlet assembly 21 and the air outlet assembly 23, and the rotating assembly 30 can drive the housing assembly 10 and the blowing assembly to rotate synchronously, to implement blowing in different directions.

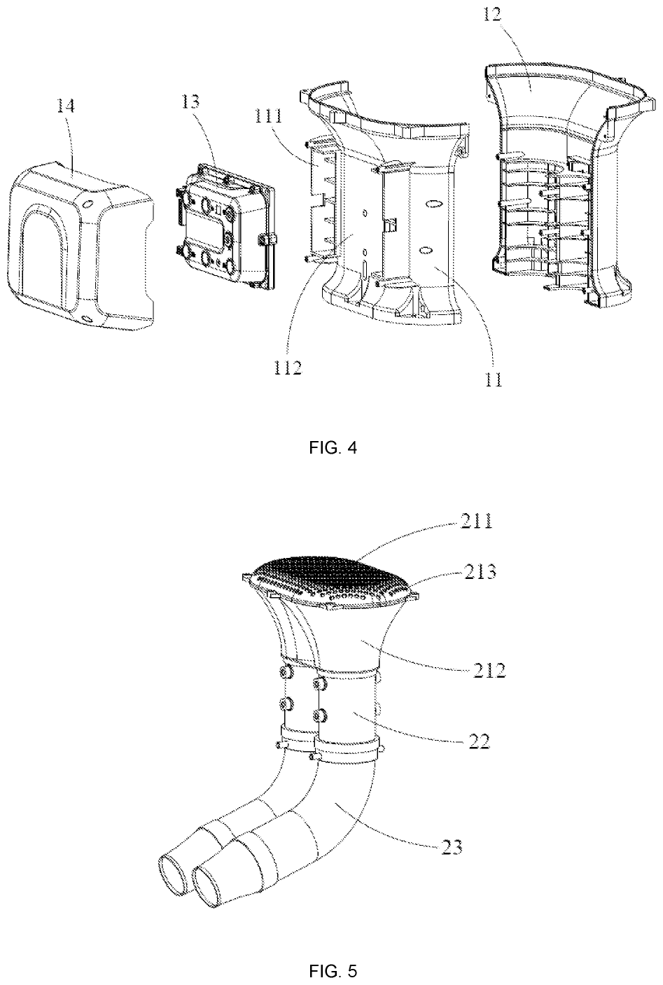

As shown in FIG. 4, the housing assembly 10 includes a first housing 11 and a second housing 12 that are assembled with and fastened to each other, a control assembly 13 fastened on an outer side of the first housing 11, and a protective cover 14 covering an outer side of the control assembly 13. After being assembled, the first housing 11 and the second housing 12 enclose to form an accommodating cavity 15 that runs continuously from top to bottom. The duct assembly 22 is accommodated in the accommodating cavity 15 and are electrically connected to the control assembly 13, so that the control assembly 13 controls the duct assembly 22 to operate.

The protective cover 14 and the first housing 11 are matched with each other, to limit the control assembly 13 between the protective cover 14 and the first housing 11. In an embodiment, extension walls 111 are formed on an outer wall of the first housing 11, the control assembly 13 is limited and accommodated in a limiting cavity 112 enclosed by the extension walls 111, and the protective cover 14 and the extension walls 111 are fastened through screw riveting, to further limit and fasten the control assembly 13 in the limiting cavity 112. The control assembly 13 may be a circuit board or may be of another structure, provided that the duct assembly 22 can be controlled to normally operate. A specific structure of the control assembly 13 is not limited herein.

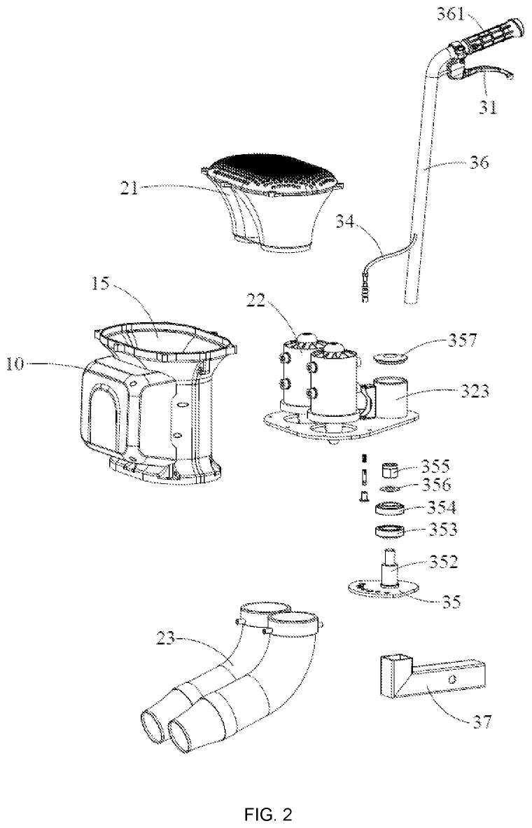

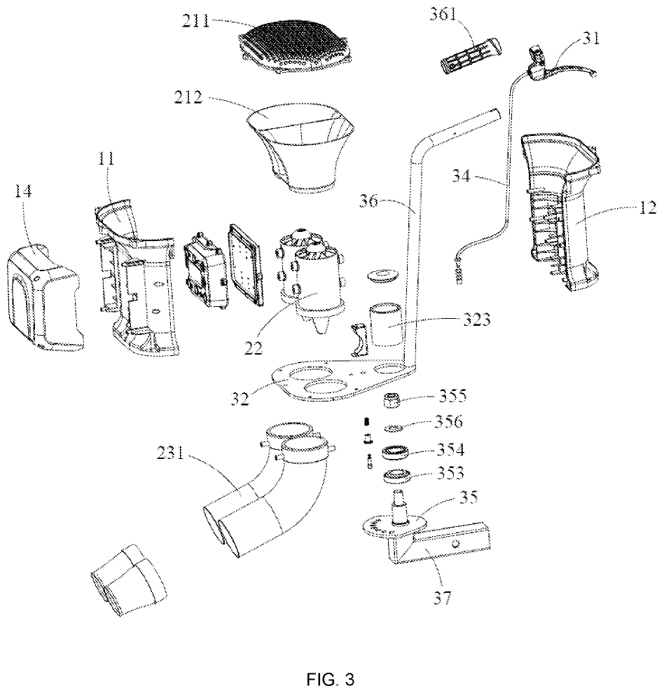

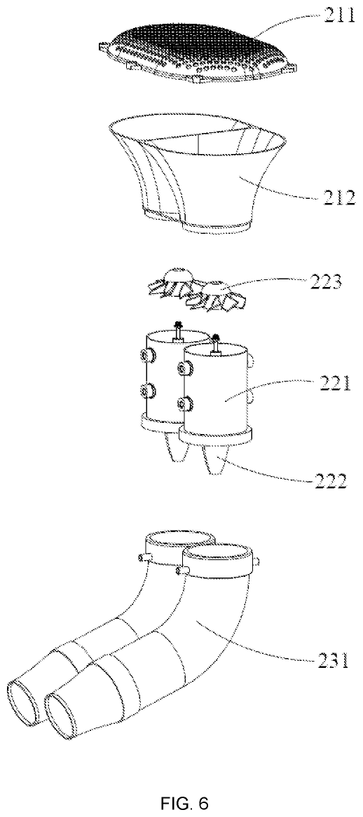

As shown in FIG. 5, FIG. 6, FIG. 2, and FIG. 3, the air inlet assembly 21 includes an air inlet cover 211 and an air inlet pipe 212 connected to the air inlet cover 211, and an air inlet 213 is disposed on the air inlet cover 211, so that an inner cavity of the air inlet pipe 212 can be in communication with the outside, thereby forming a complete air inlet channel. The air inlet cover 211 is matched with one end of the first housing 11 and one end of the second housing 12, to close the accommodating cavity 15. “Close” herein means that the duct assembly 22 are fastened in the accommodating cavity 15 and are not affected by another component, and an operator cannot put a hand into the accommodating cavity 15, but does not mean “seal”.

The duct assembly 22 includes a motor 221, a guiding cone 222 fitting with and mounted at a first end of the motor 221, and an axial fan 223 fitting with and mounted at a second end of the motor 221. In this embodiment, the motor 221 is a brushless motor. The air inlet pipe 212 is accommodated in the accommodating cavity 15 and is connected to the motor 221. The axial fan 223 is disposed close to the air inlet pipe 212, and is fastened on a motor shaft of the motor 221. In this way, the motor 221 drives the axial fan 223 to rotate when being started. A negative pressure is generated at the air inlet 213, so that external air enters the air inlet pipe 212 through the air inlet 213 and passes through the axial fan 223, to form a straight through-type blowing manner. Finally, the air flows out from the air outlet assembly 23 under the action of the guiding cone 222.

In an embodiment, a gap between the axial fan 223 and an inner wall surface of the motor 221 is set to be extremely small. In this way, kinetic energy generated when the axial fan 223 rotates can be converted into wind energy, and the wind energy can pass through only the axial fan 223. In this case, blowing efficiency is extremely high.

Because the axial fan 223 is used as a fan blade in the present disclosure, to ensure both a high air flow rate and a large air volume, a plurality of air outlet ducts is added to increase a blowing area. In some embodiments, two duct assemblies 22 are provided, the air outlet assembly 23 includes two air outlet pipes 231 connected to the two duct assemblies 22 respectively, and the air outlet pipe 231 is an elbow pipe.

In an embodiment, the brushless motor is used as the motor 221 and the axial fan 223 is used as the fan blade, thereby improving blowing efficiency and reducing energy consumption with a small volume and a long service life.

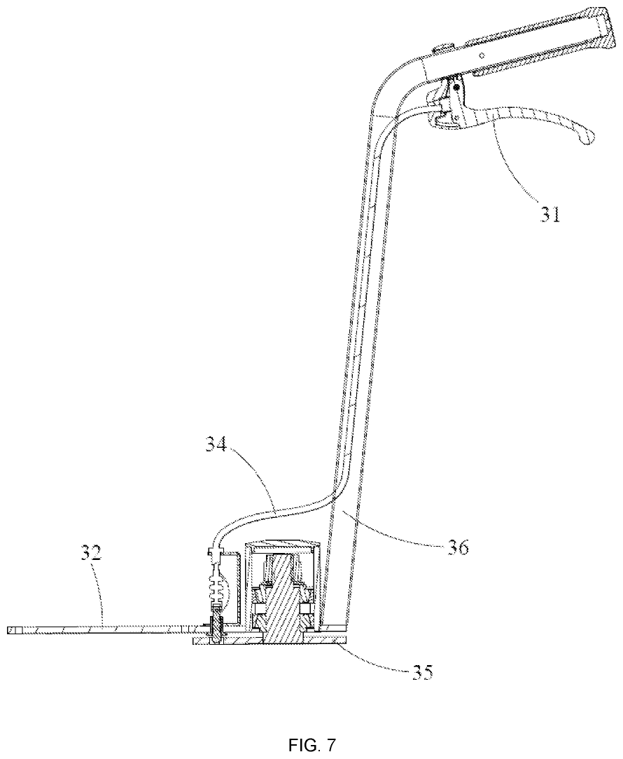

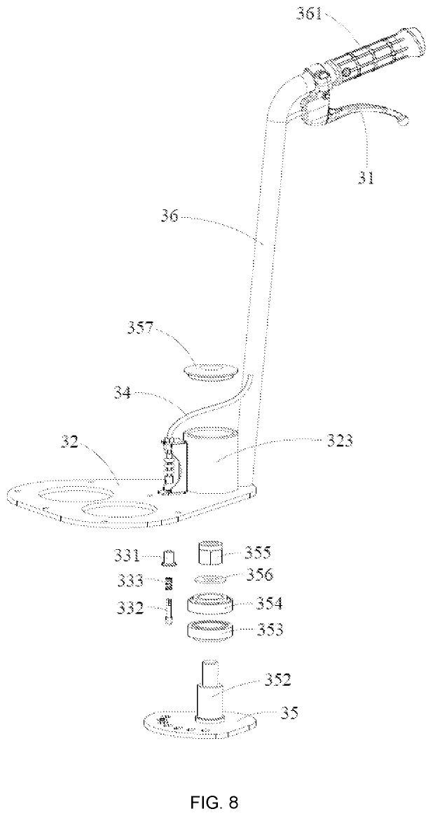

As shown in FIG. 7 to FIG. 10, FIG. 2, and FIG. 3, the rotating assembly 30 includes a control handle 31, a first turntable 32, a fastening assembly 33 penetrating through the first turntable 32, a control cable 34 connecting the control handle 31 with the fastening assembly 33, and a second turntable 35 located below the first turntable 32. A first end of the first turntable 32 is fixedly connected to the housing assembly 10 and the blowing assembly 20, and a second end of the first turntable 32 is rotatably connected the second turntable 35. Specifically, both the first housing 11 and the second housing 12 are fastened on an upper surface of the first turntable 32 and are disposed perpendicular to the first turntable 32. In this way, the duct assembly 22 are also disposed perpendicular to the first turntable 32. The first turntable 32 is provided with penetrating holes 321 for the two air outlet pipes 231 to pass through, and the two penetrating holes 321 are close to the first end of the first turntable 32 and are arranged side by side.

A plurality of fastening holes 351 is disposed on the second turntable 35. The control handle 31 is configured as follows: when the control handle 31 is pressed, the control cable 34 drives the fastening assembly 33 to detach from the fastening hole 351; and after the control handle 31 is released, the fastening assembly 33 drives the control cable 34 to automatically reset, and then the fastening assembly 33 is reinserted into the fastening hole 351. In an embodiment, the plurality of fastening holes 351 on the second turntable 35 is arranged in an arc shape and are spaced from each other, and there is an equal distance between each fastening hole 351 and a rotation axis of the first turntable 32. Therefore, the fastening assembly 33 can be inserted into different fastening holes 351 to implement fastening after the first turntable 32 rotates relative to the second turntable 35. The following describes in detail a specific structure, a rotation principle, and a fastening principle of the rotating assembly 30.

The rotating assembly 30 further includes a handheld rod 36, the control handle 31 is fastened at a top part of the handheld rod 36, and the control cable 34 passes through the handheld rod 36 and is partially accommodated in the handheld rod 36, to manage the control cable 34 conveniently. A handheld sleeve 361 is further disposed at the top part of the handheld rod 36, and the handheld sleeve 361 is hold by the operator, to prevent slippage when the handheld rod 36 is operated. A bottom end of the handheld rod 36 is fixedly connected to the second end of the first turntable 32 away from the penetrating holes 321, so that the operator can drive, by controlling the handheld rod 36, the first turntable 32 to rotate.

The fastening assembly 33 includes a fastening base 331 fixedly connected to the first turntable 32, a fastener 332 fixedly connected to a tail end of the control cable 34, and a spring 333 sleeved outside the fastener 332, and the fastener 332 passes through the fastening base 331 and limits the spring 333 between the fastener 332 and the fastening base 331. In this way, when the control handle 31 is pressed, the control cable 34 can pull the fastener 332 to move upward, so that the spring 333 is compressed, until the fastener 332 is detached from the fastening hole 351; and after the control handle 31 is released, the spring 333 pushes the fastener 332 to move downward, so that the fastener 332 is reinserted into the fastening hole 351. In an embodiment, the fastener 332 is a pin.

The first turntable 32 is further fastened with a limiting base 322, and one end of the control cable 34 connected to the fastener 332 is accommodated in the limiting base 322 and is capable of moving up and down synchronously with the fastener 332 in the limiting base 322. In this embodiment, the limiting base 322 is disposed in a U shape and is erected on the first turntable 32, the fastening base 331 simultaneously passes through the first turntable 32 and the limiting base 322 from a bottom part of the first turntable 32, and one end of the control cable 34 is limited in the limiting base 322. Such a design is used to better accommodate the control cable 34, so that an overall appearance of the on-vehicle axial flow blower 100 is cleaner and more aesthetic.

An on-vehicle tube 37 is fastened at a bottom part of the second turntable 35, and the on-vehicle tube 37 is configured to fasten the second turntable 35 to a vehicle, then to fasten the on-vehicle axial flow blower 100. The on-vehicle tube 37 is provided, so that the on-vehicle axial flow blower 100 in the present disclosure can be applied to various vehicles.

The rotating assembly 30 further includes a bearing fastening post 352 fastened on the second turntable 35, a bearing and a locking member 355 that are sleeved on the bearing fastening post 352, and a bearing sleeve 323 fastened on the first turntable 32. The bearing fastening post 352 and the bearing pass through the first turntable 32 and are accommodated in the bearing sleeve 323, so that the first turntable 32 can rotate relative to the second turntable 35. In an embodiment, the bearing includes a first bearing 353 and a second bearing 354 located above the first bearing 353, the first bearing 353 is sleeved on the bearing fastening post 352 and passes through the first turntable 32 together with the bearing fastening post 352, to be accommodated at a bottom part of the bearing sleeve 323, and the second bearing 354 enters from a top part of the bearing sleeve 323 and is sleeved on the bearing fastening post 352. The locking member 355 also enters from the top part of the bearing sleeve 323 and is sleeved at a top part of the bearing fastening post 352, and the locking member 355 is configured to be tightly locked with and fastened to the bearing fastening post 352, to connect the first turntable 32 with the second turntable 35.

Before the locking member 355 is assembled, a spring sheet 356 may be further assembled above the second bearing 354 first, so that the second bearing 354 can be stably mounted in the bearing sleeve 323 by pressing the locking member 355 against the spring sheet 356. In this embodiment, the locking member 355 is, but is not limited to, a nut. A dust-proof cover 357 is further disposed on the top part of the bearing sleeve 323. The dust-proof cover 357 is configured to seal an inner cavity of the bearing sleeve 323, to prevent dust from entering the bearing sleeve 323.

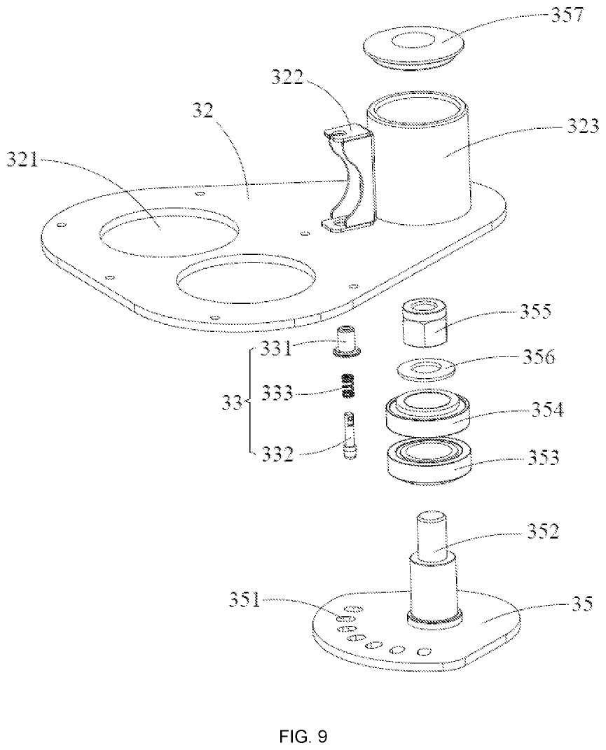

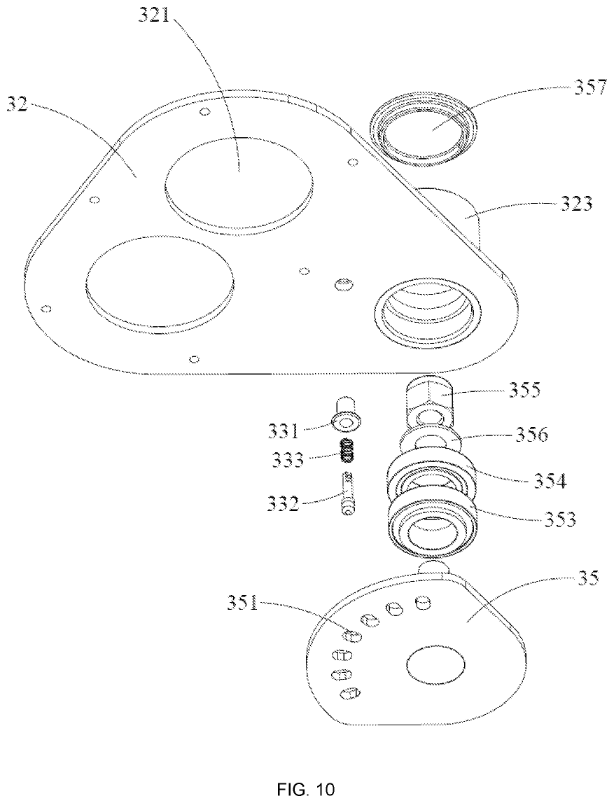

It can be seen from FIG. 9 and FIG. 10 that, on one hand, a mounting position of the bearing sleeve 323 and positions of the two penetrating holes 321 constitute a triangle, so that structures on the first turntable 32 have better stability, and maximum space utilization is achieved on the first turntable 32; and on the other hand, the bearing sleeve 323 is disposed between the handheld rod 36 and the limiting base 322, so that the structures on the first turntable 32 are arranged more compactly, and a distance between the bearing fastening post 352 and the handheld rod 36 is shortest. In this way, the operator conveniently controls the first turntable 32 to rotate relative to the second turntable 35, and therefore, an operation is simpler with fewer efforts.

It can be learned from the foregoing content that, in the present disclosure, the rotating assembly 30 connects the first turntable 32 with the second turntable 35 by using the first bearing 353 and the second bearing 354, to implement a rotation function, and the control handle 31 is used to drive the control cable 34 and the fastening assembly 33 to pass through the first turntable 32 to reach the fastening hole 351 of the second turntable 35, to implement a fastening function.

The following describes a mounting process and an operation principle of the rotating assembly 30 as a whole.

Rotation structure: First, the first bearing 353 is sleeved on the bearing fastening post 352 connected to the second turntable 35, and then the three components as a whole are connected to the bearing sleeve 323 of the first turntable 32 by using the first bearing 353. Then, the second bearing 354 enters the bearing fastening post 352 from above the bearing sleeve 323 and is connected to the bearing sleeve 323. Then, the second bearing 354 is fastened and tightly locked by sleeving the spring sheet 356 and the locking member 355, so that the first turntable 32 and the second turntable 35 are connected as a whole. Finally, the dust-proof cover 357 is connected to the bearing sleeve 323 to prevent dust from entering. The two bearings are disposed, so that the first turntable 32 can rotate by 360° relative to the second turntable 35.

Fastening structure: The fastener 332 passes through the spring 333 and is pressed into the fastening base 331, a tail end of the fastener 332 is connected to the control cable 34, the fastening base 331 is fastened inside the limiting base 322 after passing through the first turntable 32, and the control handle 31 is fastened by tightly screwing a screw after being sleeved on the handheld rod 36. In this case, the control handle 31 can be held to drive the control cable 34 to compress the spring 333, so that the fastener 332 moves upward to detach from a current fastening hole 351. After the first turntable 32 is adjusted by a rotation angle, the control handle 31 is released, so that the fastener 332 moves downward to a corresponding fastening hole 351 under the action of the spring 333, thereby fastening the on-vehicle axial flow blower 100.

In some embodiments of the present disclosure, after the axial fan 223 is used for the on-vehicle axial flow blower 100, compared with a centrifugal fan blade, there are advantages of a significantly improved air flow rate, a smaller volume of a required space, higher blowing efficiency at a same condition. In addition, a plurality of air outlet assemblies 23 may be added to simultaneously operate to increase an air volume. In addition, a structure of the rotating assembly 30 is adjusted. In this way, quick direction turning can be implemented through rotatable connection between the first turntable 32 and the second turntable 35. And the fastening assembly 33 and the plurality of fastening holes 351 can fit with each other by pressing the control handle 31, then the first turntable 32 is fixedly connected with the second turntable 35, the rotation angle is limited, and rotational blowing is more easily and conveniently operated.

The foregoing embodiments are merely used to describe rather than to limit the technical solutions of the present disclosure. Although the present disclosure is described in detail with reference to preferred embodiments, a person of ordinary skill in the art should understand that modifications or equivalent replacements may be made to the technical solutions of the present disclosure without departing from the scope of the technical solutions of the present disclosure.

What is claimed is:

1. An on-vehicle axial flow blower, comprising:
a housing assembly;
a blowing assembly, comprising an air inlet assembly, an air outlet assembly, and a duct assembly connected between the air inlet assembly and the air outlet assembly, wherein the duct assembly comprises a motor, a guiding cone mounted at a first end of the motor, and an axial fan mounted at a second end of the motor; and
a rotating assembly, comprising a control handle, a first turntable, a fastening assembly penetrating through the first turntable, a control cable connecting the control handle with the fastening assembly, and a second turntable arranged below the first turntable, wherein a first end of the first turntable is fixedly connected to the housing assembly and the blowing assembly, a second end of the first turntable is rotatably connected to the second turntable, a plurality of fastening holes is disposed on the second turntable, and the control handle is configured as follows: when the control handle is pressed, the control cable drives the fastening assembly to detach from the fastening hole; and after the control handle is released, the fastening assembly drives the control cable to automatically reset, and then the fastening assembly is reinserted into the fastening hole.

2. The on-vehicle axial flow blower according to claim 1, wherein the plurality of fastening holes on the second turntable is arranged in an arc shape and are spaced from each other, and there is an equal distance between each fastening hole and a rotation axis of the first turntable.

3. The on-vehicle axial flow blower according to claim 1, wherein the fastening assembly comprises a fastening base fixedly connected to the first turntable, a fastener fixedly connected to the control cable, and a spring sleeved outside the fastener, and the fastener is configured to pass through the fastening base and limit the spring between the fastener and the fastening base.

4. The on-vehicle axial flow blower according to claim 3, wherein when the control handle is pressed, the control cable is capable of pulling the fastener to move upward, the spring is compressed, and the fastener is detached from the fastening hole; and after the control handle is released, the spring is capable of pushing the fastener to move downward, so that the fastener is reinserted into the fastening hole.

5. The on-vehicle axial flow blower according to claim 4, wherein the first turntable is further fastened with a limiting base, and one end that is of the control cable and that is connected to the fastener is accommodated in the limiting base and is capable of moving up and down synchronously with the fastener in the limiting base.

6. The on-vehicle axial flow blower according to claim 1, wherein the rotating assembly further comprises a bearing fastening post fastened on the second turntable, a bearing sleeved on the bearing fastening post, and a bearing sleeve fastened on the first turntable, and the bearing fastening post and the bearing are configured to pass through the first turntable to be accommodated in the bearing sleeve, so that the first turntable is capable of rotating relative to the second turntable.

7. The on-vehicle axial flow blower according to claim 6, wherein the bearing comprises a first bearing and a second bearing arranged above the first bearing, the first bearing is sleeved on the bearing fastening post and configured to pass through the first turntable together with the bearing fastening post, to be accommodated at a bottom part of the bearing sleeve, and the second bearing is configured to enter from a top part of the bearing sleeve to be sleeved on the bearing fastening post.

8. The on-vehicle axial flow blower according to claim 7, wherein the rotating assembly further comprises a locking member, the locking member is configured to enter from the top part of the bearing sleeve to be sleeved on a top part of the bearing fastening post, and the locking member is locked on the bearing fastening post to connect the first turntable with the second turntable.

9. The on-vehicle axial flow blower according to claim 1, wherein the air inlet assembly comprises an air inlet and an air inlet pipe connected to the air inlet, the air inlet pipe is accommodated in the housing assembly and is connected to the motor, and the axial fan is arranged close to the air inlet pipe to drive external air to enter the air inlet pipe from the air inlet.

10. The on-vehicle axial flow blower according to claim 9, wherein the air inlet assembly further comprises an air inlet cover assembled to the housing assembly, and the air inlet is arranged on the air inlet cover.

11. The on-vehicle axial flow blower according to claim 1, wherein the on-vehicle axial flow blower comprises two duct assemblies, the air outlet assembly comprises two air outlet pipes connected to the two duct assemblies respectively, and the first turntable is provided with penetrating holes for the two air outlet pipes to pass through.

12. The on-vehicle axial flow blower according to claim 11, wherein the air outlet pipe is an elbow pipe.

13. The on-vehicle axial flow blower according to claim 1, wherein the housing assembly comprises a first housing and a second housing matched with each other, both the first housing and the second housing are fastened on an upper surface of the first turntable, the duct assembly is accommodated in an accommodating cavity enclosed by the first housing and the second housing, and the duct assembly is arranged perpendicular to the first turntable.

14. The on-vehicle axial flow blower according to claim 13, wherein the housing assembly further comprises a control assembly fastened on an outer side of the first housing and a protective cover covering an outer side of the control assembly, and the protective cover and the first housing are matched with each other, to limit the control assembly between the protective cover and the first housing.

15. The on-vehicle axial flow blower according to claim 1, wherein the motor is a brushless motor.
